(19) United States
(12) Patent Application Publication
(10) Pub. No.: US 2011/0145187 A1
(43) Pub. Date: Jun. 16, 2011

(54) CONFLICT FRAMEWORK FOR GUIDED STRUCTURE SYNCHRONIZATION

(75) Inventors: Gerhard Himmelsbach, Mannheim (DE); Tilman Bohnengel, Bammental (DE); Gregor Rieken, Walldorf (DE)

(73) Assignee: SAP AG, Walldorf (DE)

(21) Appl. No.: 12/639,747

(22) Filed: Dec. 16, 2009

(51) Int. Cl. G06F 17/30; G06F 3/048

(52) U.S. Cl. 707/610; 707/E17.005; 707/741; 707/758; 715/764

(57) ABSTRACT

A system and method for handling conflicts during structure synchronization. Conflicts are identified as the structure moves through the synchronization process. An intermediate structure is generated on a format of a target structure. A proposal for resolution of the identified conflicts is created. The conflicts and proposed resolutions are presented to a user. Proposals accepted by the user are applied to the intermediate structure.

### BACKGROUND OF THE INVENTION

1. Field

Embodiments of the invention relate to structure synchronization. More specifically, embodiments of the invention relate to conflict handling during structure synchronization.

2. Background

As structures move along the value chain from product development through manufacturing ultimately to service, the structure often must change. For example, the “hand over to manufacturing,” which defines the transition from product structure from engineering to manufacturing necessitates a change in the structure. The role of product development (engineering) is to develop, validate, and document a product in accordance with certain requirements. Once that product has reached a certain level of maturity, the product data, typically including drawings, documents and master data for the materials and parts list, it is handed over to manufacturing. However, the design parts list from product development, typically referred to as an engineering bill of materials or EBOM, generally does not have the one-to-one correspondence with a manufacturing parts list often referred to as the manufacturing bill of materials or MBOM. Thus, a process is necessary to synchronize the source structure (the EBOM) with the target structure (the MBOM). During this synchronization, conflicts between the structure and/or attributes of the structure are often identified.

Notably a single synchronization of the MBOM with the EBOM is unlikely to be sufficient over the product lifecycle. Typically, design changes over time on the engineering side require resynchronization. This is only one example of the myriad environments in which structure synchronization is necessary or desirable. Accordingly, it would be desirable to have an efficient way to track conflicts occurring propose resolutions of the conflicts and allow those resolutions to be applied as the structure moves through the synchronization.

### SUMMARY

A system and method for handling conflicts during structure synchronization is disclosed. Conflicts are identified as the structure moves through the synchronization process. An intermediate structure is generated on a format of a target structure. A proposal for resolution of the identified conflicts is created. The conflicts and proposed resolutions are presented to a user. Proposals accepted by the user are applied to the intermediate structure.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a system according to one embodiment of the invention.

FIG. 1B shows a schematic of a sample synchronization process according to one embodiment of the invention.

FIG. 2 is a flow diagram of an operation in one embodiment of the invention.

### DETAILED DESCRIPTION

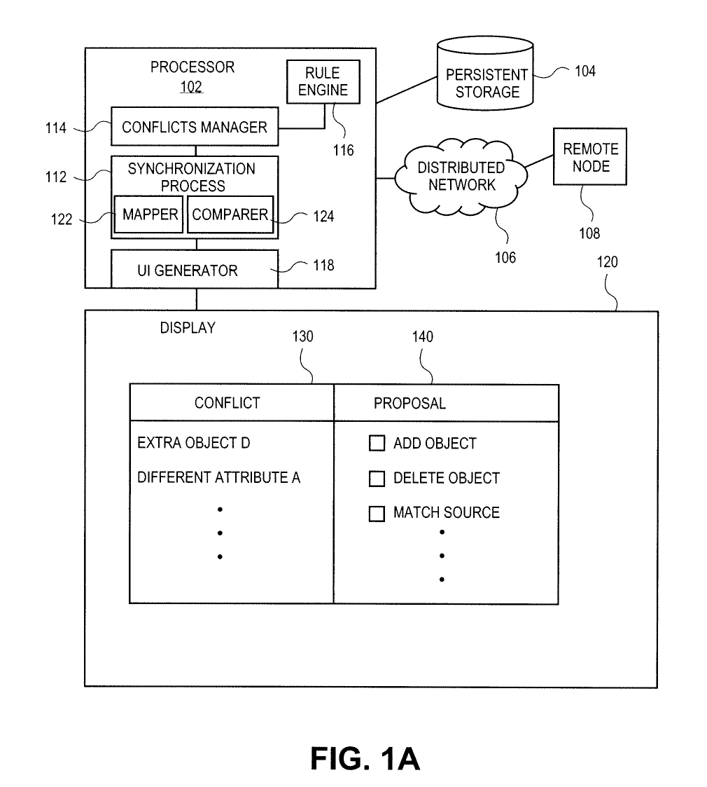

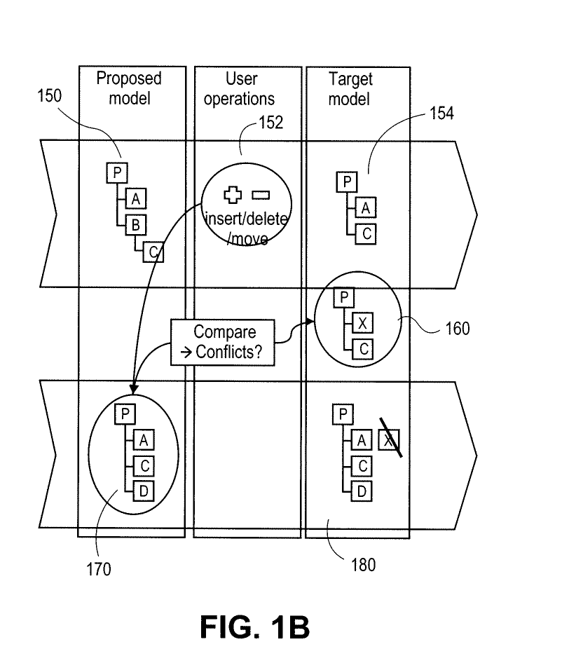

FIG. 1A is a block diagram of a system according to one embodiment of the invention. Processor 102 is coupled to a persistent storage 104 and a remote node 108 across a distributed network 106. Processor 102 is also coupled to display 120. Distributed network 106 may be a local area network (LAN) or a wide area network (WAN), such as the Internet.

A synchronization process 112 executes on processor 102 to ensure synchronization of source and target structures. Synchronization process 112 may be called by an application (not shown) executing on, for example, processor 102 or remote node 108 as the case may be. Synchronization process 112 includes a mapper 122 and a comparer 124, both of which set conflict checkpoints during the synchronization process. In some embodiments, the mapper 122 and comparer 124 may be enhanced with any of application specific, industry specific or customer specific mapping/comparing respectively.

FIG. 1B shows a schematic of a sample synchronization process according to one embodiment of the invention. Two synchronization passes are shown. In the initial case, synchronization process creates a proposed model 150 in the format of a target structure, from a source structure (not shown). A user may then reform operations 152, which include insert, delete, remove to generate a target model 154 that can be directly converted into the target structure (not shown). As shown, the user elected to delete element B and move element C to be a child of element P.

Typically, these user operations are stored in persistent storage 104 for reapplication the case of a subsequent synchronization responsive to a future change of the source structure. Once the structure leaves the synchronization process, it may be modified further outside the control of that process on either the target side or the source side. For example, target model 154 may be modified in manufacturing to replace element A with element X to create structure 160.

When, for example, in response to a change in engineering synchronization process is called again. Mapper 122 maps the source structure into proposed model 170 consistent with the target structure during this mapping, conflicts may be identified at the conflict checkpoint. Then mapper 122 then creates a conflict as a table entry in conflict manager 114. Common conflicts found by the mapper are i) missing component or ii) extra component. In one embodiment, conflicts manager 114 is instantiated as a class. Conflict manager 114 accumulates conflicts occurring during the synchronization process 112 and uses rule engine 116 to generate proposed resolutions of the conflict. The proposed resolutions are stored in the conflict manager 114 association with the conflict to be resolved.

The synchronization process 112 continues with comparer 124, comparing proposed model 170 with existing target model 160 and identifying additional conflicts existing between those structures. Common conflicts found in the comparer and i) missing attributes or ii) extra attributes. Additional conflict table entries are created in conflict manager 114 by comparer 124 responsive to the identification of these conflicts. Conflict manager 114 again uses rule engine 116 to identify proposed resolutions of the conflicts and stores those in association with the conflicts to be resolved.

UI generator 118 may be used to generate a display of the conflict list 130 and proposed resolution list 140 to a user. In this way the user may select the proposal that yields the desired target structure. In this example, the identified conflicts were an extra object D and different attribute A. Proposed resolutions are add (object D) and match source (keep A delete X). Thus, attribute X is eliminated in the target structure in favor of attribute A and new object D is included to yield target model 180, which may be directly converted to the target structure.

Some proposals may be executed without user input. For example, some proposals may just provide definitions or trigger alerts and can be executed without impacting the ultimate target structure.

In some embodiments, multiple proposals are provided for each conflict. For example, if for a particular element of a structure, no material attribute is present. The conflict can be resolved by i) deleting the element or ii) specifying the material. If, for example, there are two optional materials, the proposals may be i) delete element, ii) use material one; or iii) use material two, this results in three proposals may be presented to the user. Alternatively, a most favored proposal may be presented with an additional proposal only presented if that most favored proposal is rejected.

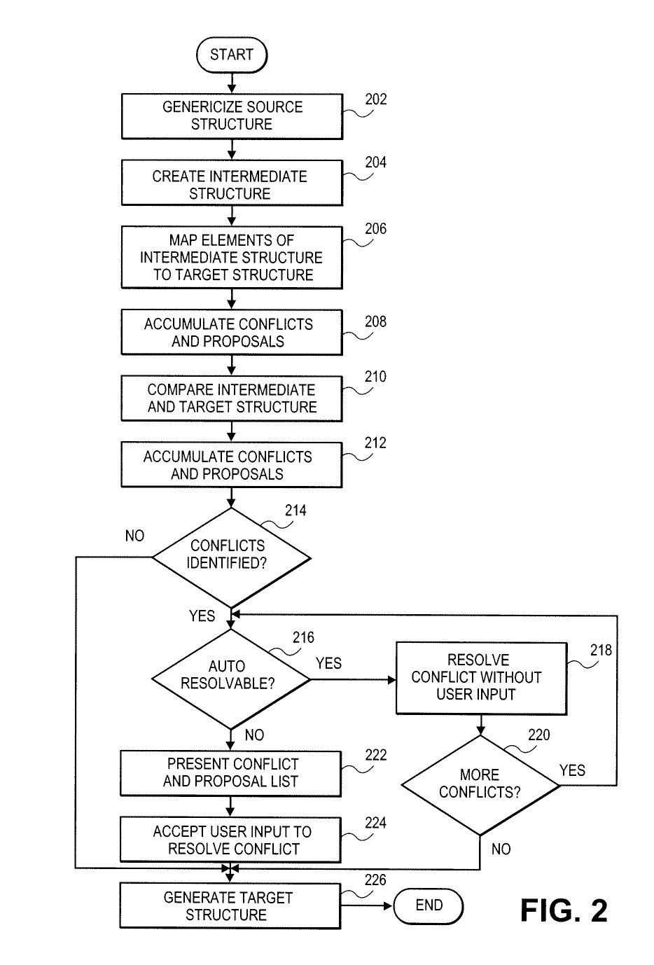

FIG. 2 is a flow diagram of an operation in one embodiment of the invention. At block 202, a source structure is genericized. At block 204, an intermediate structure is created having the target structure format. At block 206, the intermediate structures map to the target structure and conflicts are identified. At block 208, the conflicts are accumulated in a conflict manager. At block 210, a comparison is done between the intermediate structure and the target structure at block 212 resulting conflicts are accumulated in the conflict manager.

At decision block 214, a determination is made whether conflicts have been identified during the synchronization. If conflicts have been identified, a determination is made at block 216 if they are not auto resolvable. If they are auto resolvable, the conflicts are resolved without user input at block 218. A determination is then made if more conflicts exist at 220. If at decision block 216 the conflicts are not auto resolvable, a conflict and proposal list is presented to a user at block 222. At block 224, user input to resolve the conflict is accepted then at block 226 the target structure is generated and returned to the calling application.

In one embodiment, execution of proposals is performed by a method call in the conflict manager. The conflict manager calls the execute_action method of a corresponding action implementation of each proposal. Once the action is successfully executed, the conflict is removed from that table in the conflict manager. In some cases, attribute conflicts require grouping to ensure that interdependencies between attributes are handled appropriately. To that end, in one embodiment, the proposals are ordered by reference key and action type. Once an action type has been executed for a reference node, all collected changes are applied to the target structure.

In some embodiments, the conflict manager exposes a generic interface and the parameters passed have a generic structure. While this increases flexibility, care should be taken in passing parameters as the interface needs to handle different kinds of actions. Differentiation between parameters to execute action and parameters to generate proposals is required.

While embodiments of the invention are discussed above in the context of flow diagrams reflecting a particular linear order, this is for convenience only. In some cases, various operations may be performed in a different order than shown or various operations may occur in parallel. It should also be recognized that some operations described with respect to one embodiment may be advantageously incorporated into another embodiment. Such incorporation is expressly contemplated.

Elements of embodiments of the present invention may also be provided as a machine-readable medium for storing the machine-executable instructions. The machine-readable medium may include, but is not limited to, flash memory, optical disks, compact disks read only memory (CD-ROM), digital versatile/video disks (DVD) ROM, random access memory (RAM), erasable programmable read-only memory (EPROM), electrically erasable programmable read-only memory (EEPROM), magnetic or optical cards.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
identifying a set of conflicts during a process to synchronize a first structure with a second structure;
generating an intermediate structure in a format of the second structure;
generating a proposal for resolution of each conflict in the set of conflicts;
presenting at least one conflict from the set and at least one proposed resolution to a user on an electronic display;
accepting a user selection of a resolution to the at least one conflict; and
applying the resolution to the intermediate structure.

2. The method of claim 1 further comprising:
presenting a representation of the second structure to the user on an electronic display.

3. The method of claim 2 further comprising:
automatically applying a proposed resolution to at least one conflict before presenting the representation of the second structure.

4. The method of claim 1 further comprising:
collecting the set of conflicts in a conflict manager for the process.

5. The method of claim 1 wherein identifying comprises:
comparing the intermediate structure with the second structure.

6. The method of claim 1 wherein identifying comprises:
mapping element of the first structure to elements of the second structure.

7. A system comprising:
a processor;
a synchronization process executing on the processor to synchronize a source structure and a target structure; and
a conflict manager used by the synchronization process to collect conflicts between the source structure and target structure and to proposed a resolution to the conflicts collected.

8. The system of claim 7 wherein the synchronization process comprises:
a mapper to map elements of the source structure to corresponding elements of the target structure; and
a comparer to compare a representation of the source structure with a representation of the target structure to identify differences.

9. The system of claim 7 further comprising:
a persistent storage unit to retain a prior resolution of a conflict.

10. The system of claim 7 further comprising:
a rule engine accessible by the conflict manager to apply a rule set to generate the proposed resolution of the conflict.

11. The system of claim 7 further comprising:
a user interface generator to cause a display to display a graphical user interface (GUI) to permit a user to accept, reject, or modify the proposed resolution to the conflicts.

12. A computer readable medium containing instructions that when executed by a processor cause the processor to:
identify a set of conflicts during a process to synchronize a first structure with a second structure;
generate an intermediate structure in a format of the second structure;
generate a proposal for resolution of each conflict in the set of conflicts;
present at least one conflict from the set and at least one proposed resolution to a user on an electronic display;
accept a user selection of a resolution to the at least one conflict; and
apply the resolution to the intermediate structure.

13. The computer readable medium of claim 12 further containing instructions causing the processor to:
present a representation of the second structure to the user on an electronic display.

14. The computer readable medium of claim 13 further containing instructions causing the processor to:
automatically apply a proposed resolution to at least one conflict before presenting the representation of the second structure.

15. The computer readable medium of claim 12 further containing instructions causing the processor to:
collect the set of conflicts in a conflict manager for the process.

16. The computer readable medium of claim 12 wherein the instruction causing the processor to identify comprise instructions causing the processor to:
compare the intermediate structure with the second structure.

17. The computer readable medium of claim 12 wherein the instruction causing the processor to identify comprise instructions causing the processor to
map elements of the first structure to elements of the second structure.
